(19) United States
(12) Patent Application Publication
(10) Pub. No.: US 2024/0184644 A1
(43) Pub. Date: Jun. 6, 2024

(54) AUTOMATED STATUS DETERMINATION OF EVENTS COLLECTED IN RECORDS FOR NETWORK SERVICE PROVIDER

(71) Applicant: T-Mobile USA, Inc., Bellevue, WA (US)

(72) Inventor: Harold Lee McNabb, Atlanta, GA (US)

(21) Appl. No.: 18/075,201

(22) Filed: Dec. 5, 2022

(51) Int. Cl. G06F 9/54

(52) U.S. Cl. CPC G06F 9/542

(57) ABSTRACT

A method for determining status of events collected in records includes retrieving a group of records of respective events from an events database. The method includes extracting records from the group of records to generate a subgroup of records and storing the subgroup of records temporarily at a memory of a computer system. The subgroup of records is arranged serially at the memory of the computer system for processing by an application programming interface (API). Responsive to requests, the API serially processes respective records of the subgroup of records by comparing each record in the subgroup of records against indications of completed events. The method includes performing a self-executing action based on an output of the API including an indication of a status of a particular event in the subgroup of records. In one example, the status indicates that the particular event is complete or incomplete.

### BACKGROUND

Digital finance services (DFS) can manage a network service provider's services that are accessed and delivered through digital channels. The services can include payments for services or purchase items. For example, DFS is responsible for maintaining records on pending and completed payments associated with service agreements or purchases. For a telecommunications network service provider, the services and purchases can include network service plans and wireless devices configured for accessing the network (e.g., mobile phones, tablet computers, laptop computers, smart watches, or internet-of-things (loT) devices). The DFS manages communication between multiple databases as well as multiple systems (e.g., customer-associated systems, retail-associated systems, and/or financial service provider-associated systems) for managing the payments and maintaining records of the pending and completed payments.

### BRIEF DESCRIPTION OF THE DRAWINGS

Detailed descriptions of implementations of the present technology will be described and explained through the use of the accompanying drawings.

FIG. 1 is a block diagram that illustrates a wireless communications system that can implement aspects of the present technology.

FIG. 2 is a block diagram that illustrates a system for automated determination of status of events collected in records.

FIGS. 3A through 3F are illustrations of a graphical user interface (GUI) that enables automated determination of status of events collected in records.

FIG. 4 is a flow diagram that illustrates processes for an automated status determination of events collected in records.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to methods and systems for determining the status of events collected in records over multiple systems or multiple software programs. The technology includes a computer system that is in communication with an application programming interface (API) and an events database (e.g., a database storing status of certain events). In particular, the disclosed technology is configured to reconcile the status of transactional events (e.g., payments) in instances where communication delays or errors between the multiple systems or multiple software programs may have prevented the status of certain events from being recorded accurately to an events database. For example, due to communication delays or errors, the events database includes a group of records that have been pending (e.g., waiting to be completed) for a period of time. The disclosed technology provides for a system and method for reconciling such a group of records in an automated matter by the API.

In one example, an online store associated with a network service provider is configured to send an event record identifying a purchase or a service agreement made by a customer to the events database. The events database stores information about the event record including the due date for payment and the status of the payment (e.g., pending) when no payment has been received from the customer). In some instances, the customer can make a payment associated with the purchase but, due to communication delays or errors between the events database and a system or a software program that processes the payment, the events database does not receive any indication that the payment has been completed. The events database, therefore, does not get updated, as it should. In such instances, the computer system can be configured to collect a group of events from the events database that have been pending for a period of time and modify them to be processed by the API for determining whether the events in the group of events have been completed or not. In one example, the computer system is configured to modify the group of events so that events are batch processed by an API (e.g., the group of events is configured to be converted into a comma-separated-value (csv) format). However, to avoid a time-consuming conversion to the csv format for batch processing, the computer system can store and arrange the group of events in a serial format (e.g., in a queue) for processing by the API.

In another example, a computer system causes an events database to identify event records that each satisfy a criterion and includes a parameter. The criterion can include a time-dependent value for an event. The parameter indicates a type or source of the event. The computer system can retrieve a group of records of respective events from the events database. The group of records can have the parameter and satisfy the criterion. The computer system can extract records from the group of records to generate a subgroup of records configured for converting into a csv format. The subgroup of records is also configured for batch processing by an API. The computer system can store the subgroup of records temporarily at a memory of the computer system without converting the subgroup of records into the csv format. The subgroup of records can be arranged serially at the memory of the computer system for processing by the API. Responsive to requests in an application layer protocol, the computer system can cause serial processing of respective records of the subgroup of records by the API. The computer system can remove each record of the subgroup of records from the memory of the computer system when processed by the API. The API can compare each of the records in the subgroup of records against indications of completed events. The computer system can perform at least one self-executing action based on an output of the API, including an indication of a status of a particular event in the subgroup of records. The status can indicate that the particular event is complete or incomplete.

In another example, a computer system causes an events database to identify event records that each satisfy a criterion and includes a parameter. The criterion can include a time-dependent value for an event. The parameter includes a type or source of the event. The computer system can retrieve a group of records of respective events from the events database. The group of records can have the parameter and satisfy the criterion. The computer system can extract records from the group of records to generate a subgroup of records. The computer system can store the subgroup of records temporarily at a memory of the computer system. The subgroup of records can be arranged serially at the memory of the computer system for processing by the API. Responsive to requests in an application layer protocol, the computer system can cause serial processing of respective records of the subgroup of records by the API. The computer system can remove each of the records in the subgroup of records from the memory of the computer system when processed by the API. The API can compare each of the records in the subgroup of records against indications of completed events. The computer system can perform at least one self-executing action based on an output of the API including an indication of a status of a particular event in the subgroup of records. The status can indicate that the particular event is complete or incomplete.

In yet another example, a system includes a computer system and an events database, where an API is configured for determining the status of events collected in records. The events database can identify event records that each satisfy a criterion and includes a parameter. The criterion includes a time-dependent value for an event, and the parameter includes a type or source of the event. The computer system can retrieve from the events database a group of records of respective events having the parameter and satisfying the criterion. The computer system can extract records from the group of records to generate a subgroup of records configured for converting into a csv format and batch processing with the API. The computer system can store the subgroup of records temporarily at a memory of the computer system without converting the subgroup of records into the csv format. In one example, the subgroup of records can be arranged serially at the memory of the computer system for processing by the API. Responsive to requests in an application layer protocol, the API can serially process respective records of the subgroup of records. Each of the records in the subgroup of records can be removed from the memory of the computer system when processed by the API. The API can compare each of the records in the subgroup of records against indications of completed events. The computer system can perform at least one self-executing action based on an output of the API including an indication of a status of a particular event in the subgroup of records. The status can indicate that the particular event is complete or incomplete.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

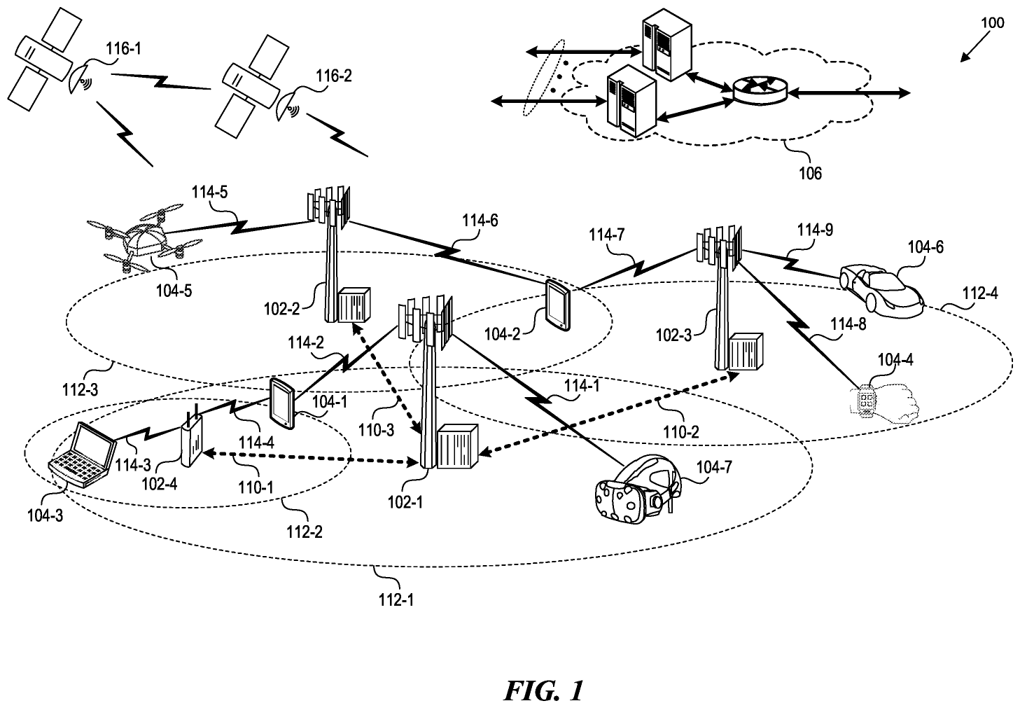

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104-1 through 104-7 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The geographic coverage area 112 for a base station 102 can be divided into sectors making up only a portion of the coverage area (not shown). The network 100 can include base stations of different types (e.g., macro and/or small cell base stations). In some implementations, there can be overlapping geographic coverage areas 112 for different service environments (e.g., Internet-of-Things (IOT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term eNB is used to describe the base stations 102, and in 5G new radio (NR) networks, the term gNBs is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the wireless telecommunications network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provides data to a remote server over a network; loT devices such as wirelessly connected smart home appliances, etc.

A wireless device (e.g., wireless devices 104-1, 104-2, 104-3, 104-4, 104-5, 104-6, and 104-7) can be referred to as a user equipment (UE), a customer premise equipment (CPE), a mobile station, a subscriber station, a mobile unit, a subscriber unit, a wireless unit, a remote unit, a handheld mobile device, a remote device, a mobile subscriber station, terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102, and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites such as satellites 116-1 and 116-2 to deliver services anywhere and anytime and provide coverage in areas that are unreachable by any conventional Terrestrial Network (TN). A 6G implementation of the network 100 can support terahertz (THz) communications. This can support wireless applications that demand ultra-high quality of service requirements and multi-terabits per second data transmission in the 6G and beyond era, such as terabit-per-second backhaul systems, ultrahigh-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low User Plane latency. In yet another example of 6G, the network 100 can implement a converged Wi-Fi and Core architecture to increase and improve indoor coverage.

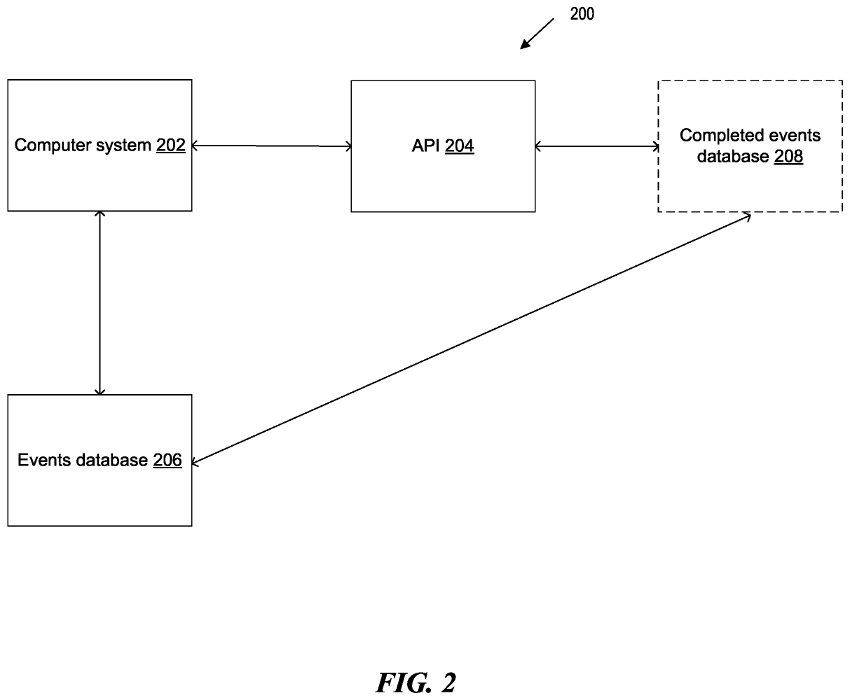

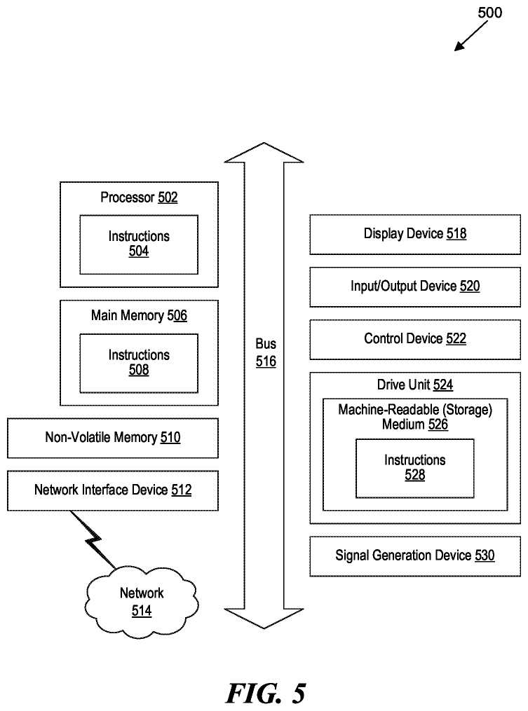

FIG. 2 is a block diagram that illustrates a system 200 for automated determination of the status of events collected in records. The system 200 can be associated with a network service provider. For example, the system 200 can be part of a DFS system of a telecommunications network service provider configured to manage financial services accessed and delivered through digital channels. The system 200 can include a computer system 202, an API 204, and an events database 206. For example, the computer system 202 can be in communication (e.g., wired or wireless communication) with the events database 206 and the API 204. The computer system 202 can correspond to or include a computer system 500 described with respect to FIG. 5.

The computer system 202 can be configured to receive data from the events database 206 and extract and/or modify the data so that the data is configured to be processed by the API 204. The computer system 202 is configured to display (e.g., by a display device 518 in FIG. 5) a graphical user interface (GUI) that allows a user to provide user inputs (e.g., via a control device 522 in FIG. 5) that causes the system 200 to perform certain operations. The computer system 202 can also be configured to temporarily store the extracted and/or modified data so that it can be serially processed by the API 204.

The API 204 is a software interface that is configured to provide communication between two or more software programs. The API 204 can operate based on standards or other documents that describe how to establish communication interfaces between respective software programs. The API 204 can, for example, allow communication between a first software program and a second software program that is different from the first software program. The communication can include processing data received from the first software program based on indications received from the second software program. The processing can include reconciling accounts identified in the data received from the first software program based on the indications received from the second software program. The API 204 can be caused to perform operations by a user of the computer system 202 so that the API 204 performs operations based on user inputs received on the computer system 202.

In some implementations, the events database 206 is separate and distinct from the computer system 202. The events database 206 can also be independent of the API 204. The events database 206 is configured to store data associated with certain events. The events can include, for example, financial transactions such as payments that are managed by the DFS system. The events database 206 can include identification information for each of the transactions (e.g., a time and date of transaction, place of transaction, or transaction identification number) as well as the status of each of the transactions. The status can indicate, for example, whether each of the transactions is pending (e.g., a payment has not been received) or completed (e.g., a payment has been received).

In one example, a customer purchases a service plan or a product from an online store associated with the network service provider. The service plan can include paying for the service periodically (e.g., biweekly, monthly, or annual payments). Similarly, the customer can purchase the product with an agreement to pay for the product in periodic installments for a pre-set period of time (e.g., monthly payments over two years). Upon the purchase, the events database 206 can receive an indication of the purchase including identification information and indications of the associated payments (e.g., amounts of payments due and due dates). The indication can also include the status of the payments stating that the respective payments are pending or completed. The events database 206 stores the information regarding the purchases and can update the information according to indications received from other databases or systems.

In some implementations, the system 200 includes, or is in communication with, completed events database 208 (e.g., the computer system 202 and the events database 206 are in communication with the completed events database 208). The completed events database 208 can be configured to receive and store status (e.g., pending or completed) for the events (e.g., payment requests) associated with the system 200. In one example, the completed events database 208 is configured to receive indications when payments are made and store the information accordingly. The completed events database 208 can further send the indications to the events database 206 and/or the computer system 202.

In some examples, the customer has purchased a service plan or an installment purchase that includes monthly payments. The events database 206 receives indications of the required monthly payments including identification information and the status of the monthly payments. For example, the events database 206 includes a date when a monthly payment is due. The status of the monthly payment will remain pending until the events database 206 receives an indication that the monthly payment is made. However, in some instances, the status of a completed payment fails to be updated in the events database 206. This can be, for example, due to delays or errors in communication between the completed events database 208 and the events database 206 and/or the computer system 202. The delays or errors can arise, for example, from communication issues between different systems or different software programs. In such instances, the status of the events can be determined by a user of the system 200 using the automated processes described herein.

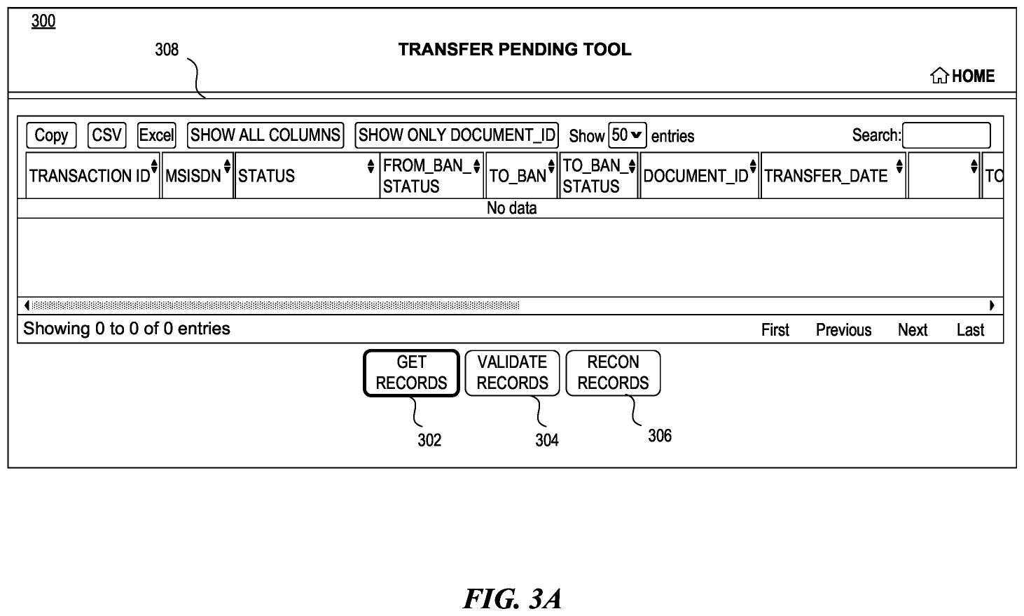

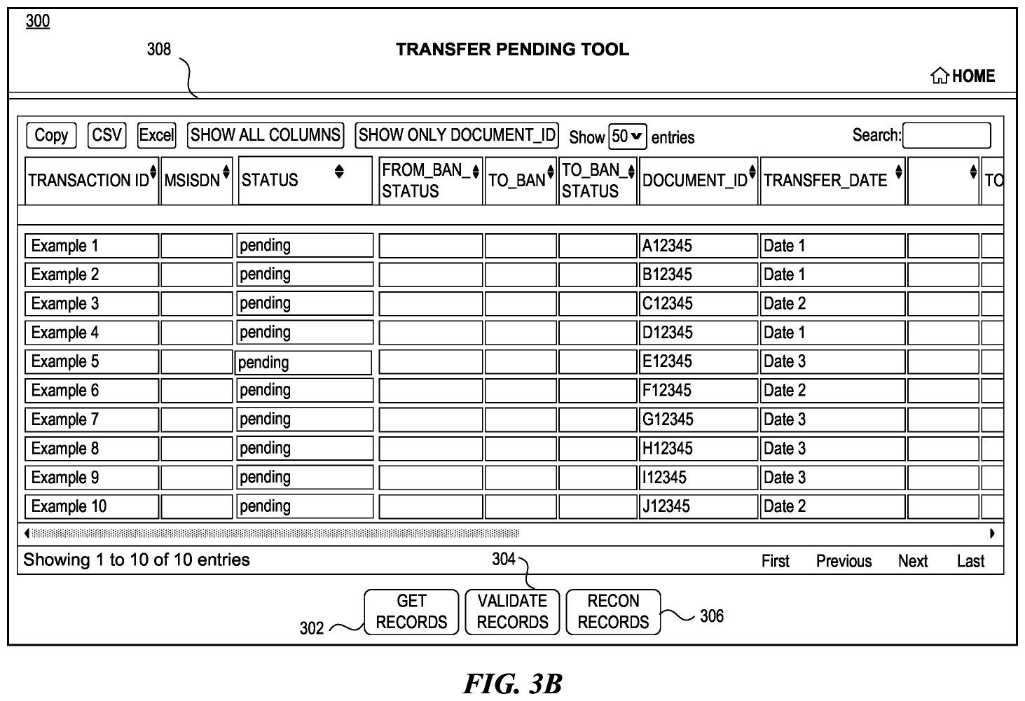

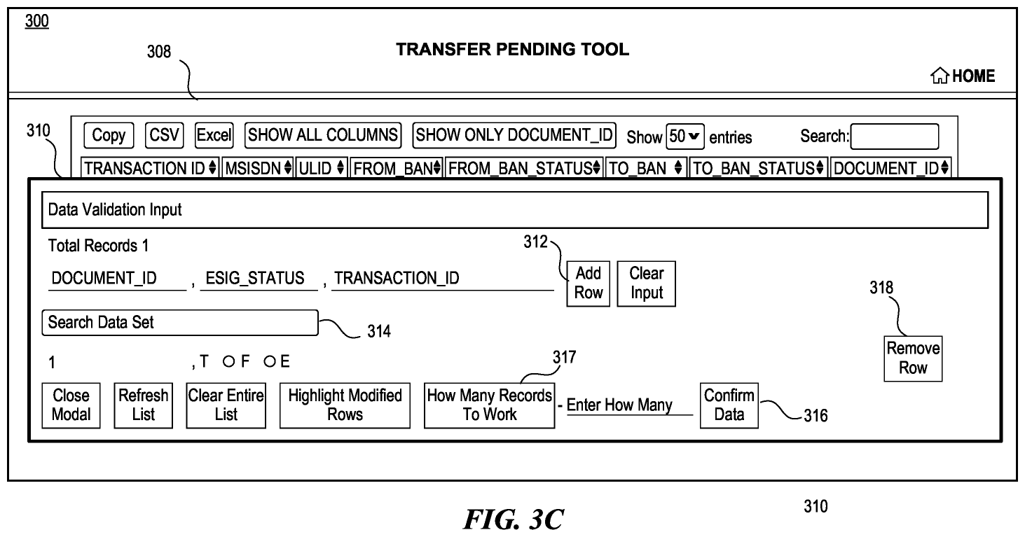

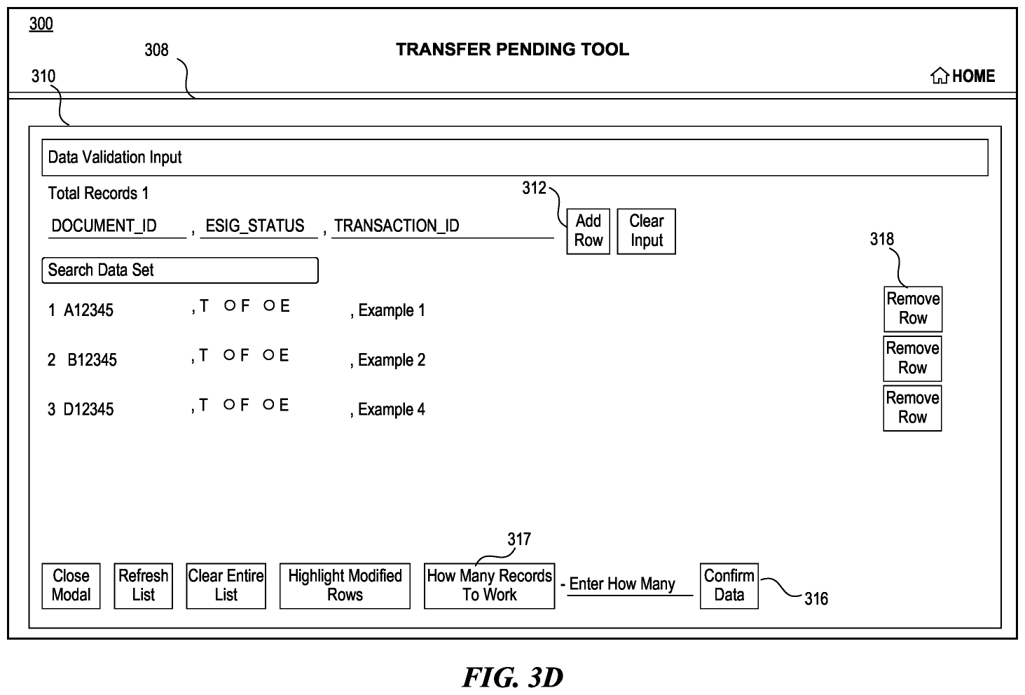

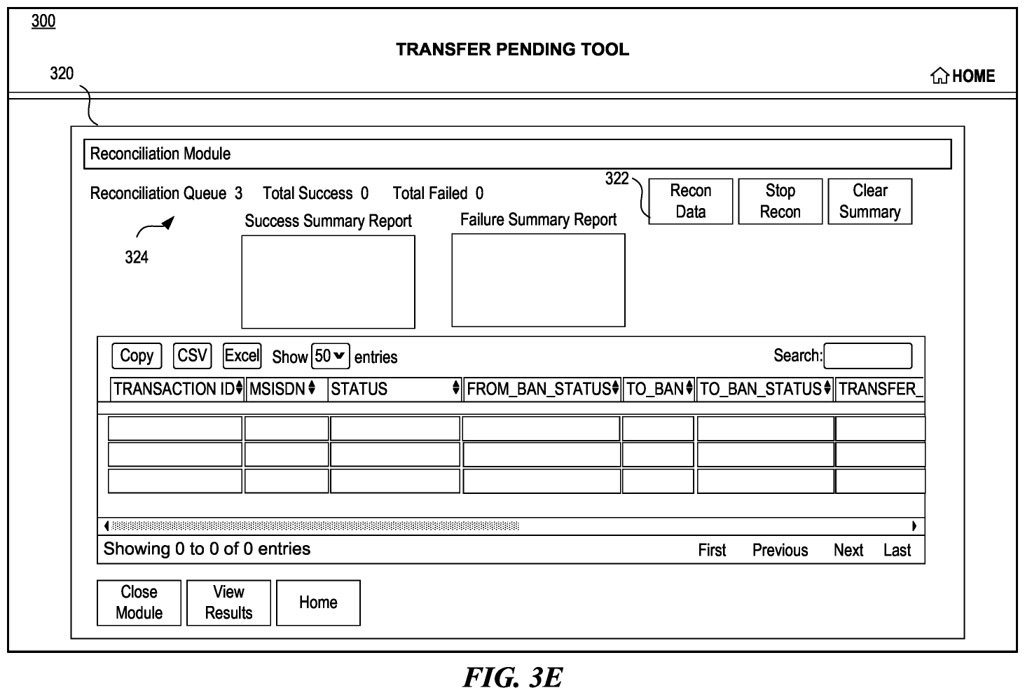

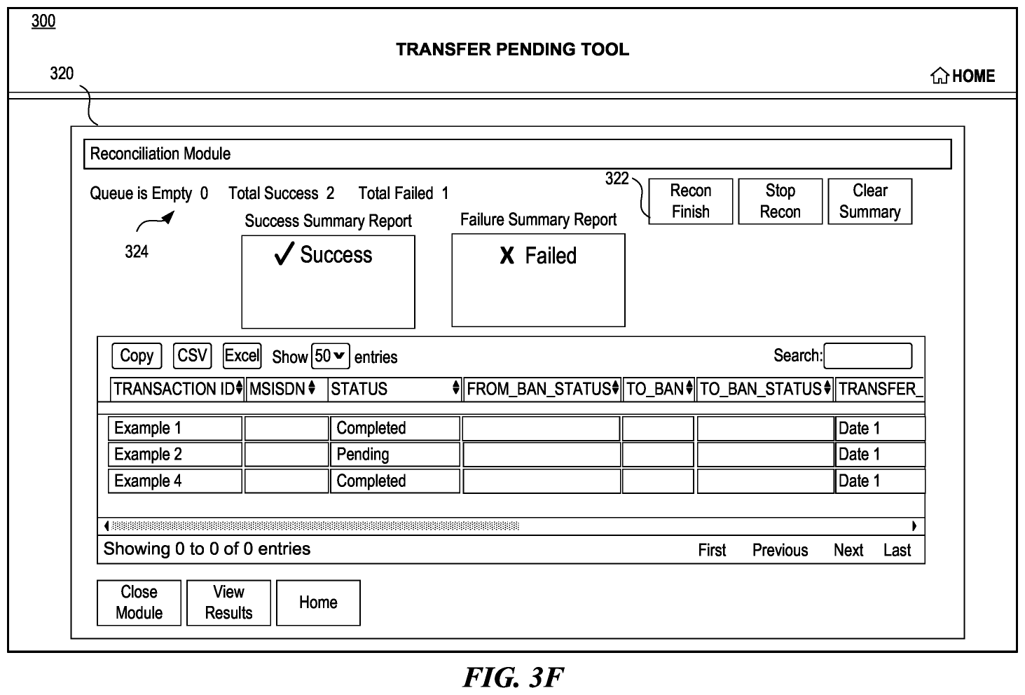

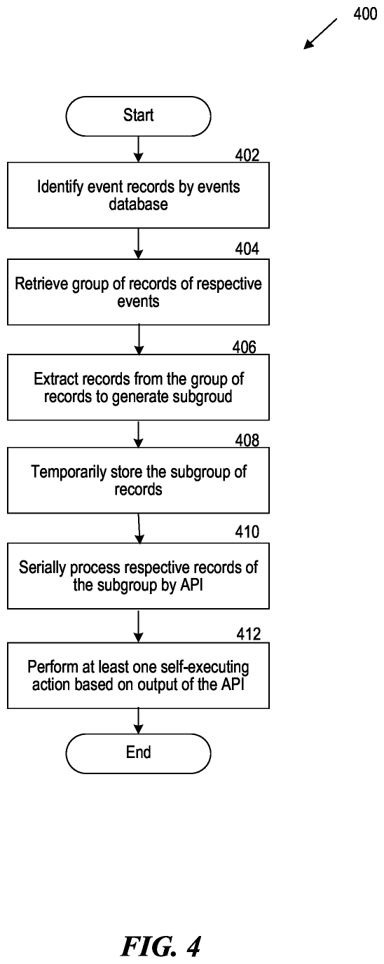

FIGS. 3A through 3F are illustrations of a GUI 300 that enable automated determination of status of events collected in records. The GUI 300 can be displayed by the computer system 202 described with respect to FIG. 2. The GUI 300 is configured to display multiple affordances. An affordance refers to an object displayed on a GUI that is associated with a particular operation and causes a computer system to perform the particular operation in response to a user interface on the affordance. The object can include a text, symbol, image, or space for entering user input (e.g., an affordance for entering a search term). Affordances enable convenient and intuitive ways for a user to operate a system via a GUI. In response to a user input (e.g., by a mouse click or touchpad tap) on a respective affordance, the computer system 202 is configured to perform certain processes (e.g., processes 400 described with respect to FIG. 4). FIG. 3A illustrates a starting window of the GUI 300 that is displayed by the computer system 202 after a user launches the respective software application on the computer system. The GUI 300 includes an affordance 302 configured for retrieving records, an affordance 304 for validating records, and an affordance 306 for reconciling records. The GUI 300 further includes a records portion 308 configured to display data corresponding to multiple events such as financial transactions (e.g., payments).

The multiple events can be organized in the format of a table. The table includes information associated with the multiple events. The information can include “transaction ID” indicating unique identifiers for each of the events; “MSISDN” indicating unique identifiers for subscriptions in a Global System of Mobile communications (e.g., providing a mapping between a telephone number and a subscriber identity); “status” indicating whether the events are pending or completed; “transfer date” indicating the date on which a purchaser has received the product or service; and/or any other relevant parameters. The table of the records portion 308 can include data to be extracted and/or modified to a format that can be processed by the API 204 of the system 200 in FIG. 2. As shown in FIG. 3A, the records portion 308 includes no events (e.g., the table displays a “no data” indication).

In response to a user input on the affordance 302 (e.g., a “get records” affordance) in FIG. 3A, the computer system 202 is configured to retrieve a group of records from the events database 206, shown in the window of the GUI 300 in FIG. 3B. For example, the computer system 202 sends a request to the events database 206 to identify event records that satisfy a particular criterion. For example, the criterion can be a time-dependent value indicating that an event has been in a pending mode for a certain period of time since a respective transaction has been initiated. The criterion can thereby correspond to a payment that has not been paid for a threshold time (e.g., the payment has not been paid for a week or two weeks since its due date). The request can also include one or more parameters and cause the events database to identify event records that satisfy the one or more parameters. The one or more parameters can include a type of the event or a source of the event. In some implementations, the type of event indicates that is the event a payment for a one-time purchase or a periodical payment for a service or installment purchase. In some implementations, the source of the event indicates whether the purchase was made online or in a retail store. Furthermore, the source can indicate a geographical location of the retail store or a geographical area of a customer that has purchased a network service plan for a particular geographical area.

The group of records shown in FIG. 3B includes events having transaction identifications (IDs) of Example 1, Example 2, . . . , Example 10. All the events have a status of “pending” indicating that the events database 206 has not received indications that the payments associated with the respective transaction IDs have been completed. The records portion 308 can also indicate document IDs for the respective events as well as transfer dates (e.g., the date on which a purchaser has received the product or service). In FIG. 3B, the events having transaction ID's Example 1, Example 2, . . . , Example 10 are each associated with a transfer date (e.g., Date 1, Date 2, or Date 3). The group of records including events having transaction IDs Example 1 through Example 10 can be temporarily stored by the computer system 202 in a format that can be preconfigured for batch processing by the API 204. Generally, the API 204 can perform batch processing on records that are in a csv format. The group of records can be thereby temporarily stored in a format that would allow the group of records to be converted into a csv format. However, converting large sets of data into a csv format can be time-consuming and can require a significant amount of storage space. Csv files also have limitations in presenting complex configuration data, does not provide special characters, and does not allow distinction between text and numeric values. The present technology avoids the conversion of the group or records in the csv format, as described herein.

In response to a user input on the affordance 304 (e.g., a “validate records” affordance) in FIG. 3A, the computer system 202 can be configured to display a window 310 (e.g., a pop-up window) that allows a user to preview and/or modify the group of records shown in FIG. 3B. The modification can include extracting certain events from the group of events to generate a subgroup of events so that the subgroup includes fewer events than the group of events shown in FIG. 3B. For example, the computer system 202 can extract events from the group of records based on one or more parameters provided by the user on affordance 314. In some implementations, the user can provide one or more parameters on the affordance 314 (e.g., by typing with a keyboard) and the computer system 202 reduces the events in the group of records in the records portion 308 based on the one or more parameters. The one or more parameters can be associated with a transaction ID, MSISDN, status, document ID, transfer date, and/or any other parameter included in the group of records. As shown, the parameters are indicated as columns in the records portion 308 of the GUI 300. For example, in response to a user input on the affordance 314 that indicates that the user wants to extract a subgroup from the group of records that includes events associated with a particular transfer data (e.g., Date 1), the computer system generates a subgroup of records including events associated with the particular transfer date (e.g., Example 1, Example 2, and Example 4).

In response, the generated subgroup associated with the particular transfer data can be displayed in the window 310, as shown in FIG. 3D. The computer system 202 can also reduce the number of events in the group of records based on input on an affordance 317 for entering a total number of records that a user wishes to process at a time. For example, if the group of records includes 100 events, the user can limit the number events to a smaller amount by entering a value on the affordance 317 (e.g., 50 or 25 events). In some implementations, in response to a user input on an affordance 318 (e.g., a “remove row” affordance), the computer system 202 can remove individual events or a set of events from the group of records in the records portion 308 of the GUI 300 (e.g., as shown in FIG. 3B). The computer system 202 can also add events to the group of records in the records portion 308 in response to a user input on affordance 312.

In response to a user input on an affordance 316 (e.g., “confirm data” affordance) in the window 310 (e.g., in FIGS. 3C and 3D), the computer system 202 temporarily stores the subgroup of records generated in window 310 (e.g., Examples 1, 2, and 4) on its database. Alternatively, in an instance that no subgroup was generated (e.g., a user did not reduce the number of events in the original group of records in FIG. 3B) in the window 310, the computer system 202 temporarily stores the group of events illustrated in the records portion 308 in FIG. 3C (e.g., Examples 1-10). In particular, the storing includes the subgroup or group of records without converting the records data into a csv format. Instead, the computer system 202 temporarily stores the group or subgroup of records in a serial arrangement that allows the API 204 to process the group or subgroup of records serially (e.g., storing includes temporarily occupying a memory index on the computer system). For example, each of the events in the group or subgroup of records is placed in a queue that can be sent for processing by the API.

The computer system can display a window 320 of the GUI 300 including an affordance 322 (e.g., “Recon Data” or “Recon Finish” affordance) shown in FIGS. 3E and 3F. The window 320 can be displayed, for example, in response to a user input on the affordance 306 in the GUI 300 (e.g., shown in FIGS. 3A and 3B), The window 320 can display an indication 324 notifying that the computer system 202 is storing the group or subgroup of records in the serial arrangements. As shown in FIG. 3E, the indication 324 notifies that there are three records stored in a queue (e.g., “Reconciliation Queue 3”). After temporarily storing the group or subgroup of records, in response to a user input on the affordance 322 of the window 320, the computer system 202 can generate requests to process each of the events in the queue in an application layer protocol. For example, the requests include Hypertext Transfer Protocol (HTTP) requests. In response to the requests, the API 204 processes each of the events placed in the queue stored by the computer system 202. The processing by the API 204 can include comparing each of the events in the group or subgroup of events against indications of completed events. For example, the API 204 retrieves the indications of completed events from the completed events database 208 and determines based on the comparison whether the events in the group or subgroup of events are completed or pending. The comparison can be performed based on one or more of the parameters associated with each of the events. For example, the API 204 performs an inquiry whether an event with a particular transaction ID (e.g., Example 1) has been indicated as completed in the completed events database 208. In an instance that the completed events database 208 includes indicates that the event with the particular transaction ID has been completed (e.g., a payment has been made), the API 204 determines that the event is no longer pending,

Furthermore, in response to the user input on the affordance 322, the computer system 202 displays the window 320 in the GUI 300 that includes reconciliation results as shown in FIG. 3F. The reconciliation results include the group or subgroup of records with an update status indication (e.g., events having transaction IDs Example 1, Example 2, and Example 4 in FIG. 3F). As shown, the column corresponding to the status parameter now indicates that Example 1 and Example 4 have been completed while in FIG. 3B their status was pending. Accordingly, the status of Example 2 remains pending in accordance with a determination by the API 204 that the Example 2 events have not been closed (e.g., no payment has been received in accordance with the completed events database 208). In FIG. 3F, window 320 indicates that processing of the records temporarily stored in the queue is performed. For example, the indication 324 notifies that there are no records stored in the queue (e.g., “Queue is Empty”) and affordance 322 notifies that reconciliation is finished (e.g., “Recon Finish”).

FIG. 4 is a flow diagram that illustrates processes 400 for automated status determination of events collected in records for a network service provider (e.g., a wireless network service provider). The processes 400 can be performed by the system 200 described with respect to FIG. 2. The events collected in records can be associated with service agreements or user device purchases for users subscribing to the network service provider.

At 402, the events database (e.g., the events database 206 in FIG. 2) can identify event records that each satisfy a criterion and includes a parameter. The criterion and parameter are predefined values that allow a user to conveniently search for and retrieve relevant event records automatically in response to a simple user input on a GUI (e.g., a user input on the affordance 302 in FIG. 3A). The criterion and parameter are predetermined based on an API assigned to process the event records (e.g., the API 204).

In some implementations, the event records include indications of payment requests associated with transactions. The time-dependent value can indicate whether a payment request has been pending for longer than a preset threshold time. For example, the API 204 is programmed to reconcile financial transaction event records (e.g., payments) and therefore the criterion and parameter are predefined to identify event records associated with pending or completed payments. The criterion can include a time-dependent value for an event. The time-dependent value can indicate a threshold time for an event with a pending status in the records (e.g., a payment due date for an event has been one day, 5 days, a week, two weeks, or a month ago and the payment is still pending) or a threshold transfer date for events (e.g., all events that have a transfer date on a particular date or before that and are still pending). The parameter can include a type or source of the event. The source of the event can be selected from an online transaction or a retail store transaction. The type of event can be selected from a service agreement and a purchase agreement that requires either a one-time payment or periodic payments (e.g., installments). The type of event is identified based on a parameter of the events records. For example, the document ID and transaction ID in FIG. 3B can be associated with the type or source of the event.

In some implementations, the records including the parameter and satisfying the criterion include payment requests sent to customers associated with a network service provider. For example, the system 200 is associated with a network service provider. The network service provider provides its customers service plans (e.g., periodic access to the network) as well as purchases (e.g., wireless devices for accessing the network). The payment requests can be one-time payments or periodic (e.g., monthly payments).

At 404, the computer system can retrieve a group of records of respective events from the events database (e.g., for example the group records in FIG. 3B having transaction IDs Example 1 through Example 10). For example, the computer system 202 can retrieve the group of records from the events database 206 in FIG. 2). The group of records can have the parameter and satisfy the criterion (e.g., indicated by the transaction ID, status, document ID, and transfer data in FIG. 3B).

At 406, the computer system can extract records from the group of records to generate a subgroup of records. In some implementations, the computer system can modify the subgroup of records based on a user input. For example, the user can provide inputs on a GUI (e.g., the GUI 300 in FIG. 3C) displayed by the computer system to reduce the number of events in the group of records. The number of events can be reduced based on one or more parameters entered by the user on the affordance 314 or by a total number of events on the affordance 317 in FIG. 3C. In an instance where the user does not wish to reduce the number of events in the group of events, the computer system can forgo extracting the records and continue the processes with the original group of records.

The group or subgroup of records are configured for batch processing by the API (e.g., the API 204). Generally, the group or the subgroup of records are in a format configured for converting the records into a csv format. For example, as shown in FIG. 3B, the group of records including events with transaction IDs Example 1 through Example 10 are arranged in columns and rows that can be converted into the csv format.

At 408, the computer system can store the subgroup of records temporarily at a memory of the computer system without converting the subgroup of records into the csv format. This is because, as previously described, converting large datasets of records into the csv format is consuming and can take up a significant amount of storage space. Instead, the computer system can arrange the subgroup of records serially (e.g., in a queue) in the memory of the computer system for processing by the API.

Responsive to requests in an application layer protocol, at 410 the computer system can cause serial processing of respective records of the subgroup of records by the API. The application layer protocol can be an HTTP. For example, the computer system generates HTTP requests that cause the API to process each of the events in the group or subgroup of records arranged in a queue to be processed one by one by the API. In some implementations, the computer system can generate the requests in the application layer protocol based on the respective records in the subgroup. The requests include event identification indications corresponding to the respective records (e.g., the transaction ID in FIG. 3B). Each request can also include a unique header and authorization that can allow the API to process the respective requests with appropriate credentials.

The processing by the API can include comparing each of the events in the group or subgroup of records against indications of completed events. For example, comparing the respective records against the indications of completed events includes comparing the respective records against the indications of completed events based on the respective records (e.g., based on transaction IDs associated with respective events in the group or subgroup of events). The indications of completed events can be received by the API from a database that is separate from the computer system and the API (e.g., the database of completed events database 208 in FIG. 2). For example, the API can be in communication with the database including the completed events, send requests to retrieve indications based on the events information (e.g., based on transaction IDs), and receive the indications from the database in response to the requests.

After the API has processed the events in the group or subgroup of records, the computer system can remove each record of the subgroup of records from the memory of the computer system when processed by the API.

At 412, the computer system can perform at least one self-executing action based on an output of the API including an indication of a status of a particular event in the subgroup of records. As described previously, the status can indicate that the particular event is complete or incomplete. For example, a pending status indicates that the payment request is unpaid and a completed status indicates that the payment request has been paid.

In some implementations, when a status of a particular event is indicated as completed in the status indications received from the API, the self-executed action includes storing information about the completed status associated with the particular event in the events database. When a status of a particular event is indicated as non-completed in the status indications received from the API, the self-executed action includes sending a notification (e.g., message, an alert, or a reminder) to a device of a user associated with the particular event. Sending the message, alert, or reminder can include, for example, sending an indication of the pending status to a customer management server associated with the network provider that causes the customer management server to send the message, alert, or reminder to the customer associated with the pending event.

### Computer System

FIG. 5 is a block diagram that illustrates an example of a computer system 500 in which at least some operations described herein can be implemented. In some implementations, the computer system 500 can correspond the system 200 or any of its components (e.g., the computer system 202, the API 204, the events database 206 and/or the completed events database 208). The computer system 500 can performed the processes 400 described with respect to FIG. 4.

As shown, the computer system 500 can include: one or more processors 502, main memory 506, non-volatile memory 510, a network interface device 512, display device 518, an input/output device 520, a control device 522 (e.g., keyboard and pointing device), a drive unit 524 that includes a storage medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computer system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 500. In some implementation, the computer system 500 can be an embedded computer system, a system-on-chip (SOC), a single-board computer system (SBC) or a distributed system such as a mesh of computer systems or include one or more cloud components in one or more networks. Where appropriate, one or more computer systems 500 can perform operations in real-time, near real-time, or in batch mode.

The network interface device 512 enables the computer system 500 to mediate data in a network 514 with an entity that is external to the computer system 500 through any communication protocol supported by the computer system 500 and the external entity. Examples of the network interface device 512 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable (storage) medium 526 can include any medium that is capable of storing, encoding, or carrying a set of instructions for execution by the computer system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computer system 500 to perform operations to execute elements involving the various aspects of the disclosure.

### Remarks

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

I/We claim:

1. A computer-implemented method performed by a computer system for determining status of events collected in records for a network service provider, the method comprising:
causing an events database to identify event records that each satisfy a criterion and includes a parameter;
wherein the criterion includes a time-dependent value for an event;
wherein the parameter includes a type or source of the event;
retrieving, from the events database, a group of records of respective events having the parameter and satisfying the criterion;
extracting records from the group of records to generate a subgroup of records configured for converting into a comma-separated-value (csv) format and batch processing by an application programming interface (API);
storing the subgroup of records temporarily at a memory of the computer system without converting the subgroup of records into the csv format,
wherein the subgroup of records are arranged serially at the memory of computer system for processing by the API;
responsive to requests in an application layer protocol, causing serial processing of respective records of the subgroup of records by the API,
wherein each record in the subgroup of records is removed from the memory of the computer system when processed by the API, and
wherein the API compares each record in the subgroup of records against indications of completed events; and
performing at least one self-executing action based on an output of the API including an indication of a status of a particular event in the subgroup of records,
wherein the status indicates that the particular event is complete or incomplete.

2. The method of claim 1, wherein:
the events collected in records are associated with service agreements or user device purchases for users subscribing to the network service provider, and the network service provider is a wireless service provider.

3. The method of claim 1:
wherein the indications of completed events are received from a database of a telecommunications network service provider,
wherein the database of the telecommunications network service provider is separate and distinct from the computer system and independent of the API, and
wherein the API is in communication with the database of the telecommunications network service provider and configured to access the indications of the completed events.

4. The method of claim 1, further comprising:
generating, by the computer system, the requests in accordance with the application layer protocol based on the respective records in the subgroup of records,
wherein the requests identify events of the respective records.

5. The method of claim 1:
wherein the requests identify events of the respective records in the subgroup of records, and
wherein comparing the respective records against the indications of completed events includes comparing the respective records against the indications of completed events based on the respective records.

6. The method of claim 1, further comprising:
when a status of a particular event is indicated as completed in the status indications received from the API, the computer system stores information about the completed status associated with the particular event to the events database.

7. The method of claim 1, further comprising:
when a status of a particular event is indicated as non-completed in the status indications received from the API, the computer system sends a notification to a device of a user associated with the particular event.

8. The method of claim 1:
wherein the event records including the parameter and satisfying the criterion indicate payment requests send to customers associated with a network service provider, and
wherein a pending status indicates that the payment request is unpaid.

9. The method of claim 1:
wherein the event records include indications of payment requests associated with transactions, and
wherein the time-dependent value indicates whether a payment request has been pending for longer than a preset threshold time.

10. The method of claim 1, wherein the source of the event includes an online transaction or an in-person store transaction.

11. The method of claim 1, wherein the type of the event includes a service agreement or a purchase agreement.

12. The method of claim 1, wherein the application layer protocol is a Hypertext Transfer Protocol (HTTP).

13. A computer-implemented method performed by a computer system for determining status of events collected in records, the method comprising:
causing an events database to identify event records that each satisfy a criterion and includes a parameter;
wherein the criterion includes a time-dependent value for an event;
wherein the parameter includes a type or source of the event;
retrieving, from the events database, a group of records of respective events having the parameter and satisfying the criterion;
storing the group of records temporarily at a memory of the computer system,
wherein the group of records are arranged serially at the memory of computer system for processing by an application programming interface (API);
responsive to requests in an application layer protocol, causing serial processing of respective records of the group of records by the API,
wherein each record in the group of records is removed from the memory of the computer system when processed by the API, and
wherein the API compares each record in the group of records against indications of completed events; and
performing at least one self-executing action based on an output of the API including an indication of a status of a particular event in the group of records,
wherein the status indicates that the particular event is complete or incomplete.

14. The method of claim 13:
wherein the indications of completed events are received from a database of a telecommunications network service provider,
wherein the database of the telecommunications network service provider is separate and distinct from the computer system and independent of the API, and
wherein the API is in communication with the database of the telecommunications network service provider and configured to access the indications of the completed events.

15. The method of claim 13, further comprising:
generating, by the computer system, the requests in accordance with the application layer protocol based on the respective records in the group of records,
wherein the requests identify events of the respective records.

16. The method of claim 13:
wherein the requests identify events of the respective records in the group of records, and
wherein comparing the respective records against the indications of completed events includes comparing the respective records against the indications of completed events based on the respective records.

17. A system including a computer system, an events database, and an application programming interface (API) for determining status of events collected in records, the system comprising:
at least one hardware processor; and
at least one non-transitory memory storing instructions, which, when executed by the at least one hardware processor, cause the system to:
identifying, by the events database, event records that each satisfy a criterion and includes a parameter;
wherein the criterion includes a time-dependent value for an event;
wherein the parameter includes a type or source of the event;
retrieving, by the computer system from the events database, a group of records of respective events having the parameter and satisfying the criterion;
extracting, by the computer system, records from the group of records to generate a subgroup of records configured for converting into a comma-separated-value (csv) format and batch processing the API;
storing, by the computer system, the subgroup of records temporarily at a memory of the computer system without converting the subgroup of records into the csv format,
wherein the subgroup of records are arranged serially at the memory of computer system for processing by the API;
responsive to requests in an application layer protocol, serially processing, by the API, respective records of the subgroup of records,
wherein each record in the subgroup of records is removed from the memory of the computer system when processed by the API, and
wherein the API compares each record in the subgroup of records against indications of completed events; and
performing, by the computer system, at least one self-executing action based on an output of the API including an indication of a status of a particular event in the subgroup of records,
wherein the status indicates that the particular event is complete or incomplete.

18. The system of claim 17:
wherein the indications of completed events are received from a database of a telecommunications network service provider,
wherein the database of the telecommunications network service provider is separate and distinct from the computer system and independent of the API, and
wherein the API is in communication with the database of the telecommunications network service provider and configured to access the indications of the completed events.

19. The system of claim 17, further comprising:
generating, by the computer system, the requests in accordance with the application layer protocol based on the respective records in the subgroup of records, wherein the requests identify events of the respective records.

20. The system of claim 17:
wherein the requests identify events of the respective records in the subgroup of records, and
wherein comparing the respective records against the indications of completed events includes comparing the respective records against the indications of completed events based on the respective records.
